(19) United States
(12) Patent Application Publication
(10) Pub. No.: US 2002/0183010 A1
(43) Pub. Date: Dec. 5, 2002

(54) Wireless communication systems with adaptive channelization and link adaptation

(76) Inventors: Severine E. Catreux, San Jose, CA (US); Ivana Stojanovic, Stanford, CA (US); Luc Haumonte, San Jose, CA (US); David J. Gesbert, Oslo (NO)

Correspondence Address: MAREK ALBOSZTA, LUMEN INTELLECTUAL PROPERTY SERVICES, 45 CABOT AVENUE, SUITE 110, SANTA CLARA, CA, 95051, US

(21) Appl. No.: 09/875,806

(22) Filed: Jun. 5, 2001

(51) Int. Cl. H04B 17/00

(52) U.S. Cl. 455/67.1; 455/67.3

(57) ABSTRACT

A technique for rapidly and efficiently adjusting characteristics of communication in a time-and-frequency varying channel involves the adaptive selection of a transmission mode (i.e., various kinds of modulation, coding, and antenna combining schemes) and a channelization mode (i.e., the manner in which the spectrum is used during transmission). The method includes determining signal quality estimates [32] from received signals, deriving a set of transmission mode parameters [38] from the estimates, and sending parameters [38] as feedback [40] from a receiver to a transmitter. In one embodiment, each of the transmission mode parameters [38] is a transmission mode selected for use with one of the system channelization modes. In another embodiment, transmission mode parameters [38] comprise one parameter selected for use with any system channelization mode. The method also comprises deriving a set of channelization mode parameters from channel traffic workload information and possibly other information. A single channelization mode [48] is selected from the set of channelization mode parameters, and a single transmission mode [50] is selected from the set of transmission mode parameters. The transmission mode and channelization mode may be selected jointly; or the channelization mode may be selected independently, after which the corresponding transmission mode is selected in dependence upon the selected channelization mode. In the case where only one transmission mode parameter is sent as feedback, the transmission mode selection is trivial and independent of the selected channelization mode. The selected transmission mode and channelization mode are then used for encoding and modulation [54] prior to transmission of information over the communication channel.

### FIELD OF THE INVENTION

This invention relates generally to methods and devices for wireless communications. More particularly, it relates to techniques for adaptively selecting transmission modes and spectrum use based on signal quality estimates.

### BACKGROUND ART

Wireless communication systems serving stationary and mobile wireless subscribers are rapidly gaining popularity, resulting in a need for greater efficiency in the use of the available radio frequency spectrum. This goal has been complicated because wireless communications channels between transmit and receive devices are inherently variable, so the characteristics of wireless channels, such as signal quality, generally vary in time, frequency and space. Under good conditions wireless channels exhibit good communication parameters, e.g., large data capacity, high signal quality, high spectral efficiency and throughput. However, under poor channel conditions, these parameters have significantly lower values. For example, when the wireless channel is degraded the transmitted data may experience excessive corruption, manifesting as high bit-error rates or packet error rates. The degradation of the channel can be due to a multitude of factors such as general noise in the channel, multipath fading, loss of line-of-sight path, excessive Co-Channel Interference (CCI) and other factors.

Motivated by these complications, prior art wireless systems have employed adaptive modulation of the transmitted signals with the use of feedback from the receiver as well as adaptive coding and receiver feedback to adjust data transmission to changing channel conditions. Such adaptive modulation has been applied to Single Input Single Output (SISO) as well as to Multiple Input Multiple Output (MIMO) systems, e.g., systems with antenna arrays at both the transmit and receive ends.

In both SISO and MIMO systems, however, there remains the fundamental problem of selecting the most efficient choice of the mode to be applied to the transmitted data. For general prior art on the subject the reader is referred to A. J. Goldsmith et al., “Variable-rate variable power MQAM for fading channels”, IEEE Transactions of Communications, Vol. 45, No. 10, Oct. 1997, pp. 1218-1230; P. Schramm et al., “Radio Interface of EDGE, a proposal for enhanced data rates in existing digital cellular systems”, Proceedings IEEE 48th Vehicular Technology Conference (VTC' 1998), pp. 1064-1068; and Van Noblen et al., “An adaptive link protocol with enhanced data rates for GSM evolution”, IEEE Personal Communications, February 1999, pp. 54-63.

U.S. Pat. No. 6,044,485 to Dent et al. teaches a transmission method and system which adapts the coding of data based on channel quality characteristics. Coding is selected depending on a measured signal-to-noise ratio (SNR) for the channel, where a different coding is applied to the data being transmitted for high and low SNR states of the channel. In addition, the encoding also employs information derived from the cyclic redundancy check (CRC). The method taught by Dent varies the coding rate only and not any other characteristics of the communication. These and other limitations of Dent et al. inhibit its ability to adaptively make the most efficient use of the available spectrum.

### SUMMARY

It would be an advance in the art to provide a communication technique which allows a communication system to rapidly and efficiently select the appropriate transmission mode and other characteristics of communication in a time-and-frequency varying channel. In general, the techniques of the present invention involve the adaptive selection of any transmission mode, i.e., various kinds of modulation, coding, and antenna combining schemes. In addition, the present invention provides a particularly advantageous technique for selecting the transmission mode as well as a channelization mode, i.e., the manner in which the spectrum is used during transmission. The possible transmission modes and channelization modes of the system are identified using simple parameters, e.g., integer indices. At any given time, data is transmitted using a transmission mode and channelization mode corresponding to adaptively selected parameters.

In one aspect of the invention, a method is provided for a wireless communication system comprising a transmitter and a receiver, and a corresponding wireless channel through which the receiver and the transmitter communicate. The method is implemented at the transmitter and comprises: (a) receiving feedback from the receiver, wherein the feedback comprises a set of transmission mode parameters derived from signal quality estimates and channelization parameter information; (b) selecting a channelization parameter from a set of possible channelization parameters, and a transmission mode parameter from the set of transmission mode parameters received from the receiver; and (c) transmitting receiver data over the wireless channel to the receiver in accordance with the selected transmission mode parameter and the selected channelization parameter. In one embodiment, the channelization parameter is independently selected, but the transmission mode parameter is selected to depend upon the selected channelization parameter. In another embodiment, the transmission mode parameter and channelization parameter are jointly selected.

In another aspect of the invention, a method is provided for a wireless communication system comprising a transmitter, a receiver, and a corresponding wireless channel through which the receiver and the transmitter communicate. The method is implemented at the receiver and comprises: (a) receiving signals transmitted from the transmitter over the wireless channel; (b) determining from the received signals signal quality estimates for the wireless channel; (c) determining from the signal quality estimates a set of transmission mode parameters; and (d) feeding back the set of transmission mode parameters to the transmitter. In one embodiment, the set of transmission mode parameters consists of one parameter intended for use with any channelization mode. In this case, the signal quality estimates are determined by calculating statistics of signal quality levels of the received signals transmitted with various channelization parameters, and selecting an optimal transmission mode parameter from the calculated statistics. In another embodiment, the set of transmission mode parameters contains a transmission mode selected for use with each one of the system channelization modes. In this case, the transmission mode parameter corresponding to each channelization mode is determined by separating signal quality levels into groups by channelization parameter, normalizing the signal quality levels in each group, calculating statistics of the normalized signal quality levels, and selecting an optimal transmission mode from the calculated statistics.

In another aspect of the invention, a method is provided for a wireless communication system comprising a transmitter, a receiver, and a corresponding wireless channel through which the receiver and the transmitter communicate. The method comprises: (a) feeding back from the receiver to the transmitter a set of transmission mode parameters; (b) selecting at the transmitter a channelization parameter from a set of possible channelization parameters, and a transmission mode parameter from the set of transmission mode parameters fed back from the receiver; (c) transmitting to the receiver from the transmitter receiver signals transmitted in accordance with the selected transmission mode parameter and the selected channelization parameter; (d) determining at the receiver from the transmitted receiver signals a set of signal quality estimates for the wireless channel; and (e) determining at the receiver from the set of signal quality estimates a set of new transmission mode parameters for feedback to the transmitter.

In another aspect of the invention, a method is provided for a wireless communication system comprising a transmitter, a receiver, and a corresponding wireless channel through which the receiver and the transmitter communicate. The method comprises: (a) determining at the receiver a set of signal quality estimates for the wireless channel; (b) determining at the receiver a set of transmission mode parameters from the signal quality estimates and a current channelization parameter; (c) selecting at the receiver a selected channelization parameter from a set of possible channelization parameters; (d) selecting at the receiver a selected transmission mode parameter from the set of transmission mode parameters; (e) feeding back from the receiver to the transmitter the selected transmission mode parameter and the selected channelization parameter; and (f) transmitting receiver signals from the transmitter to the receiver in accordance with the selected transmission mode parameter and the selected channelization parameter.

These techniques provide various advantages which will be evident from an examination of the following detailed description and accompanying figures.

### BRIEF DESCRIPTION OF THE DRAWING FIGURES

FIG. 1 is a block diagram of a wireless communication system in which the techniques of the present invention may be implemented.

FIG. 2 is a graph of frequency tones vs. time, illustrating frequency and time divisions of the spectrum as allocated to three subscribers according to an embodiment of the present invention.

FIG. 3 is a block diagram illustrating an embodiment of the present invention as implemented in downlink communication between a base station transmitter and a subscriber receiver.

FIG. 4 is a block diagram illustrating the selection of a transmission mode parameter dependent upon a channelization mode parameter selected independently, according to one embodiment of the present invention.

FIG. 5 is a block diagram illustrating the joint selection of the channelization and transmission mode parameters according to another embodiment of the present invention.

FIG. 6 illustrates an embodiment of the invention as applied to uplink communication between a subscriber and a base station.

### DETAILED DESCRIPTION

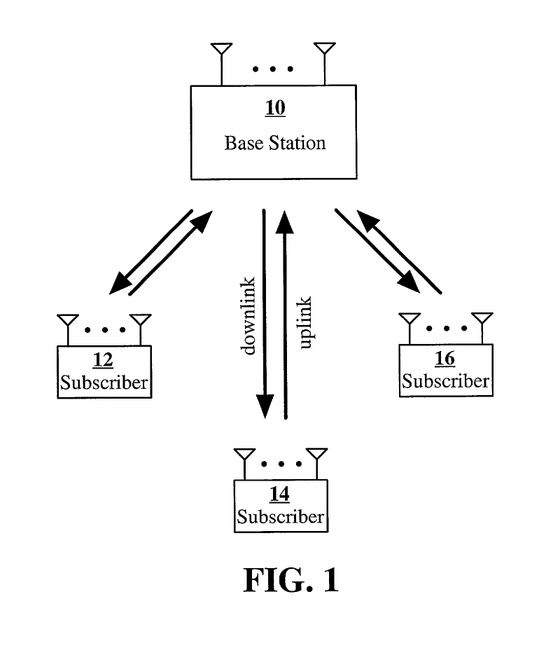

Particular embodiments of the present invention will now be described in detail with reference to the drawing figures. The techniques of the present invention may be implemented in various different types of wireless communication systems. Of particular relevance are cellular wireless communication systems, such as the system shown in FIG. 1. A base station 10 transmits downlink signals over wireless channels to multiple subscribers 12, 14, 16. In addition, the subscribers 12, 14, 16 transmit uplink signals over the wireless channels to the base station 10. Thus, for downlink communication the base station is a transmitter and the subscribers are receivers, while for uplink communication the base station is a receiver and the subscribers are transmitters. Subscribers 12, 14, 16 may be mobile or fixed. Exemplary subscribers include devices such as portable telephones, car phones, and stationary receivers such as a wireless modem at a fixed location.

The base station 10 is preferably provided with multiple antennas which allow antenna diversity techniques and/or spatial multiplexing techniques. In addition, each subscriber is preferably equipped with multiple antennas which permit further spatial multiplexing and/or antenna diversity. Single antennas, however, may also be used. Thus, Single Input Single Output (SISO), Multiple Input Single Output (MISO), Single Input Multiple Output (SIMO), or Multiple Input Multiple Output (MIMO) configurations are all possible. In any of these configurations, the communications techniques can employ single-carrier or multi-carrier communications techniques. Although the techniques of the present invention apply to point-to-multipoint systems such as shown in FIG. 1, they are not limited to such systems, but apply to any wireless communication system having at least two devices in wireless communication. Accordingly, for simplicity, the following description will focus on the invention as applied to a single transmitter-receiver pair, even though it is understood that it applies to systems with any number of such pairs.

Typically, variations of the wireless channels cause uplink and downlink signals to experience fluctuating levels of attenuation, interference, multi-path fading and other deleterious effects. In addition, the presence of multiple signal paths (due to reflections off buildings and other obstacles in the propagation environment) causes variations of channel response over the frequency bandwidth, and these variations may change with time as well. As a result, there are temporal changes in channel communication parameters such as data capacity, spectral efficiency, throughput, and signal quality parameters, e.g., signal-to-interference and noise ratio (SINR), and signal-to-noise ratio (SNR).

Information is transmitted over the wireless channel using one of various possible transmission modes. For the purposes of the present application, a transmission mode is defined to be a particular modulation type and rate, a particular code type and rate, and may also include other controlled aspects of transmission such as the use of antenna diversity or spatial multiplexing. Using a particular transmission mode, data intended for communication over the wireless channel is coded, modulated, and transmitted. Examples of typical coding modes are convolution and block codes, and more particularly, codes known in the art such as Hamming Codes, Cyclic Codes and Reed-Solomon Codes. Examples of typical modulation modes are circular constellations such as BPSK, QPSK, and other m-ary PSK, square constellations such as 4QAM, 16QAM, and other m-ary QAM. Additional popular modulation techniques include GMSK and m-ary FSK. The implementation and use of these various transmission modes in communication systems is well known in the art.

In addition to the transmission mode, communication over the wireless channel uses one of several possible channelization modes. The channelization mode is related to the spectrum use in time and/or frequency for a particular subscriber. In general, any one of various known schemes may be used to divide the total spectrum in frequency and/or time, creating a set of time/frequency subchannels that may be allocated to different subscribers. Frequency division multiple access (FDMA) is a method of dividing the wireless spectrum that associates each communication channel with a different single-frequency carrier. Often the single frequency is further divided in time using time division multiple access (TDMA). In TDMA the frequency carrier is divided into successive time frames, each containing a set of time slots. A single subchannel in an FDMA/TDMA system is thus associated with both a specific carrier frequency and a particular time slot. Orthogonal frequency division multiplexing (OFDM) is a sophisticated method of FDMA/TDMA. In OFDM each subchannel is associated with a time slot and a set of multiple subcarriers (i.e., tones) multiplexed together, each subcarrier at a different frequency and each modulated by a signal which varies discretely rather than continuously. The set of subcarrier frequencies associated with each channel is chosen from a set of N subcarrier frequency tones available to the system. In any multiplexing scheme, channel assignment, or channel allocation is the process of assigning each subscriber to one or more time intervals and/or to one or more frequency carriers or subcarriers. Typically, channel allocation is a primary task performed by a media access controller (MAC) at a system base station.

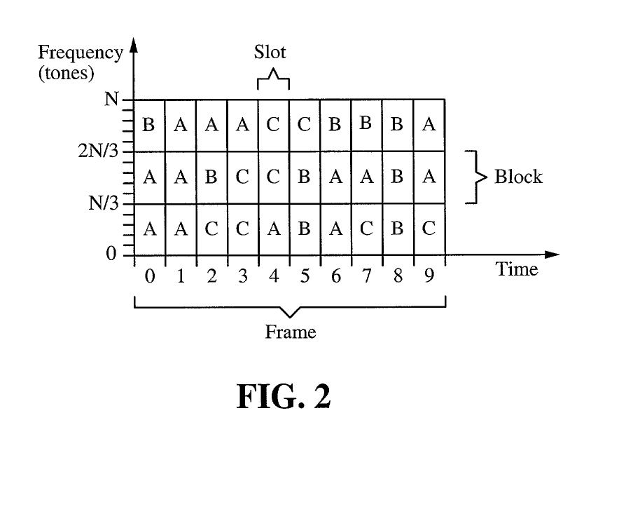

FIG. 2 is a graph of frequency tones vs. time, illustrating channel allocation for three subscribers. It will be appreciated that, in general, the N tones may be divided into any number of blocks, and the time frames may be divided into any number of time slots. In this example, the time domain is divided into frames, each having ten time slots. In addition to these divisions in the time domain, the frequency domain is divided into three blocks of tones, each block having N/3 tones. The tones in each block need not be contiguous, but may be interleaved, for example, with tones from other blocks. For simplicity of illustration, however, the blocks are shown in the figure as consisting of contiguous sets of tones. In a given time slot, the blocks may be independently allocated to distinct subscribers (indicated by the distinct labels A, B, and C in the figure). In some time slots, the three blocks are allocated to three different subscribers (e.g., slots 2 and 7). In other time slots, the three blocks are all allocated to the same subscriber (e.g., slots 1 and 8). And in some slots, two blocks are allocated to one subscriber, and the third block to another subscriber (e.g., slots 3, 4, 5, 6, and 9).

For the purposes of the present application, a channelization mode is defined as a particular set of time/frequency spectrum use constraints for a subscriber that affects the channel allocation decisions for the subscriber. For example, in one embodiment of the invention, the channelization mode specifies a particular number of blocks per time slot (i.e., proportion of total tones) required by the subscriber, a particular time slot position within each frame, and/or a minimum number of slots in each frame. In addition, the channelization mode may allow the number of blocks to vary from slot to slot within the frame, or may constrain the number of blocks to be constant for all the slots in the frame. Those skilled in the art will appreciate that many other channelization mode schemes may be used as well. In general, a channelization mode corresponds to a set of constraints regarding frequency use requirements, and time slot requirements, possibly including a number of slots required per frame, number of blocks required for each of various slots in a frame, and/or slot positioning requirements within a frame.

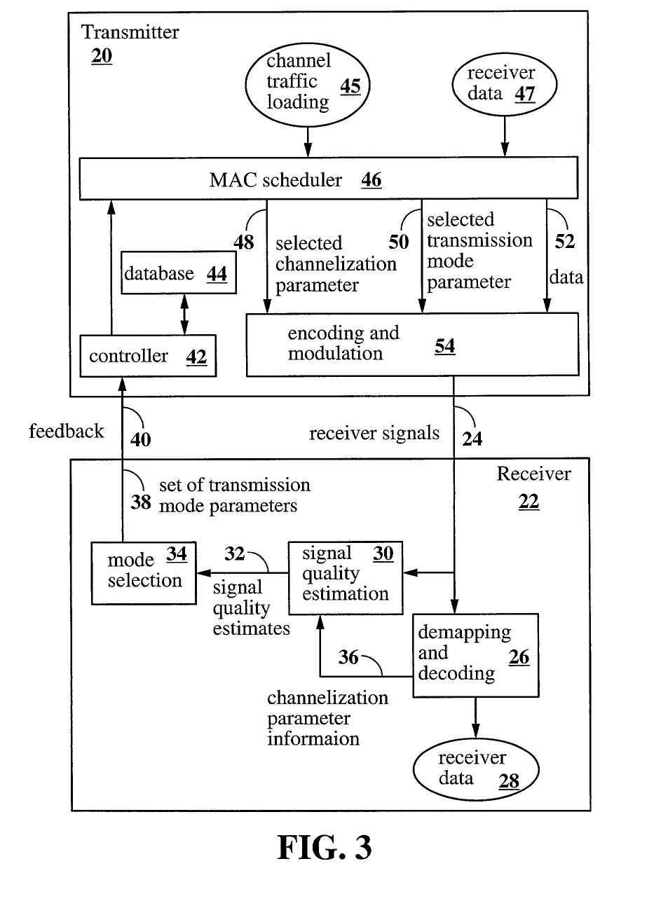

According to the principles of the present invention, both the transmission mode and the channelization mode are adaptively selected based on the varying conditions of the wireless channel in order to optimize system performance. Typically, a system is designed to allow adaptive selection from a total number B of system channelization modes, and a total number M of system transmission modes. The various techniques for adaptively selecting the transmission mode and channelization mode will now be described in detail with reference to FIGS. 3-6.

FIG. 3 illustrates an embodiment of the present invention as implemented in downlink 30 communication between a base station transmitter 20 and a subscriber receiver 22. Receiver signals 24 transmitted over the wireless downlink channel are received by receiver 22 using conventional techniques and processing elements (not shown) that are well known in the art. A demapping and decoding processing block 26 determines the transmission mode and channelization mode used, and then appropriately identifies, isolates, decodes and demodulates the receiver signals to reconstruct the original receiver data 28 intended for the subscriber.

The receiver signals also enter a signal quality estimation block 30 which determines signal quality estimates 32 for the received signals. Channelization parameter information 36 provided to the signal quality estimation block 30 is used to limit the estimation to only those signals intended for receiver 22, and to correlate the estimates with channelization parameters associated with the received signals. The signal quality estimates 32 may include, for example, signal quality statistical parameters such as first and second order statistics (e.g., time/frequency mean and variances) of signal-to-interference and noise ratio (SINR), signal-to-noise ratio (SNR), and/or power level. In addition, estimates 32 may also include various long-term signal quality estimates, such as bit error rate (BER), packet error rate (PER), and other similar measures.

The signal quality estimates 32 are provided at regular intervals to a transmission mode selection block 34. Based on the signal quality estimates 32 and possibly also on their correlated channelization parameter information 36, transmission mode selection block 34 determines a set of new transmission mode parameters 38, denoted {mᵢ}. Each parameter in the set specifies a transmission mode selected from the set of M system transmission mode parameters. In a preferred embodiment, the set of new transmission mode parameters {mᵢ} has B elements m₁, . . . , m_{B}, and each element mᵢ is selected from among M system transmission mode parameters. In other words, the set specifies one transmission mode for each of the B system channelization modes. For example, the element mᵢ is the transmission mode selected for the i^{th} system channelization mode. In a simpler embodiment, a single transmission mode parameter is selected, i.e., the set {mᵢ} has one element. In this embodiment, the selected parameter does not correspond to any particular channelization mode. In both embodiments, the set of transmission mode parameters 38 is sent by receiver 24 as feedback to the transmitter 20.

The details of various techniques for producing the signal quality estimates and selecting the transmission mode parameters {mᵢ} will now be described. In the simplest case, the set of transmission mode parameters 38 always contains exactly one parameter. In this case, the signal quality estimation block 30 measures SINR values at each time/frequency slot/block allocated to the receiver 22. A statistical analysis of the SINR values over time and frequency is carried out, without regard for the possibly different channelization modes associated with the various SINR values. The signal quality estimates 32 produced in this case comprise a set of signal quality statistical parameters. At mode selection block 34, these statistical parameters are used to determine an associated system performance level for each of the M possible system transmission modes. Each system performance level may be determined, for example, by accessing a lookup table containing a mapping from sets of signal quality statistical parameters to associated system performance levels. The result is a set of system performance levels corresponding to each of the M possible system transmission modes. The transmission mode m yielding the system performance level closest to a predetermined target level is the mode selected, and fed back to the transmitter.

In a preferred embodiment, the set of transmission mode parameters {mᵢ} contains B parameters. Each member of the set corresponds to one of the B possible system channelization parameters. In this case, the signal quality estimation block 30 measures SINR values at each time/frequency slot/block, using channelization mode information 36 to take into account the channelization mode for each slot/block. The SINR values for each slot/block are then separated into groups based on the channelization mode used for the slot/block. These groups of SINR values are then used to produce signal quality estimates for each of the B system channelization parameters, as follows.

One of the B system channelization parameters is chosen as a reference, and the separate groups of SINR levels are normalized relative to this reference. More specifically, the SINR levels of each group are normalized with respect to the reference to take account of the fact that the signal quality depends upon the transmit power per tone, which depends on the number of tones used. For example, suppose a first group corresponds to a signals transmitted using all N tones, while a second group corresponds to signals transmitted using only N/3 tones. Because the power per tone for the first group is less than the power per tone for the second group by a factor of 3, if the second group had been chosen as reference, then the SINR levels of the first group would be normalized by multiplication by a factor of 3. Conversely, if the first group had been chosen as the reference, then the SINR levels of the second group would be normalized by multiplication by a factor of ⅓.

After the SINR levels in all the groups are normalized with respect to the chosen reference, the separated groups of SINR levels are then merged, and a statistical analysis of all the normalized SINR levels results in a single set of signal quality statistical parameters, which is then provided to mode selection block 34. This entire procedure is then repeated by choosing each of the other B system channelization modes as references until all B system channelization modes have been chosen as reference. When the process is complete, signal quality estimates 32 are generated for all of the B system channelization modes.

The signal quality estimates 32 are provided to mode selection block 34, where a transmission mode is selected for each of the B system channelization modes, using the techniques such as those described above in the previous case. The result is a set of B transmission mode parameters 38, one for each of the chosen reference channelization parameters.

It will be obvious to those skilled in the art that feedback is unnecessary except in the case where the new transmission mode parameters have changed. In other words, it is necessary to send the new parameters only if the new transmission mode parameters differ from the most recent set of transmission mode parameters sent as feedback to the transmitter. If only some of the transmission mode parameters have changed, then only those which have changed need be sent as feedback. If none has changed, no feedback need be sent. Those skilled in the art will also appreciate that various coding and/or compression techniques may be used to minimize the amount of feedback required to send the updated transmission mode parameters from the receiver to the transmitter. For example, if all B elements m₁, . . . , m_{B}, have been updated and need to be sent, they may be transmitted by specifying an ordered sequence of B integers, where the i^{th} integer is the transmission mode parameter mᵢ. If a smaller number D of the parameters have been changed, however, it may be more efficient to transmit a sequence of D ordered pairs, (i(1),mᵢ₍₁₎), . . . , (i(D),m_{i(D)}), where mᵢ₍ₙ₎ is the new transmission mode parameter corresponding to the i(n)^{th} channelization parameter. Those skilled in the art will appreciate that many similar techniques can be used to efficiently transmit the new transmission mode parameters. In the embodiment where only one transmission mode parameter is calculated at the receiver, if the parameter has changed, then only one integer need be sent as feedback. It can also be noted that if the signal quality deteriorates below a predetermined threshold level, then a special set of transmission mode parameters (e.g., all parameter(s) set to zero) can be sent as feedback, indicating that the transmitter 20 should temporarily postpone transmitting data to receiver 22.

The feedback 40 from the receiver 22 comprises a set of transmission mode parameters 38 which specify transmission mode(s) derived from the signal quality estimates and possibly also from the channelization parameters measured at the receiver. Feedback 20 is communicated over the wireless channel using standard techniques well known in the art. At the transmitter 20, feedback 20 is provided to a controller 42 which detects the mode parameters 38 and looks up the mode attributes in a database 44 and thus determines the specific modulation, coding rate, antenna combining scheme, and/or any other attributes to be used for each of the transmission modes. The transmission mode parameters in the feedback message are preferably represented as integers (in order to consume minimal resource in the control messages). The function of the controller is to convert these integers back into the corresponding transmission mode attributes, using the database 44. The transmission mode attributes and their parameters are provided to a MAC scheduler 46. MAC scheduler 46 selects a particular transmission mode and a particular channelization mode that will be used for transmitting data in each time slot or group of time slots. Among other things, MAC scheduler 46 also dynamically allocates particular slot/block portions of the time/frequency spectrum to portions of data, i.e. assigns to them particular time slots and blocks of tones.

Prior to selecting a particular channelization parameter, MAC scheduler 46 first adaptively determines a set of L possible channelization parameters, from which the actual channelization parameter must be selected. Each of the L parameters is selected from the set of B system channelization parameters. For the purposes of this description, the selected set of L parameters will be represented by a set {bᵢ} of B values, where bᵢ equals one of the B system channelization parameters for L instances of i, and where bᵢ=0 for all other i. Thus the non-zero elements of the set {bᵢ} specify the selected set of L parameters. Using this notation, the sets {mᵢ} and {bᵢ} have corresponding indices, so that mᵢ is the transmission mode parameter selected for the i^{th} system channelization parameter, and bᵢ is the channelization mode parameter which also corresponds to the i^{th} system channelization parameter. Those skilled in the art will appreciate that this notation is not necessarily the form in which the data is actually represented. In practice, the selected set of L parameters may be represented, for example, in the form of a sequence of L integers j(1), . . . , j(L), where j(n) identifies the j(n)^{th} system channelization parameter as being a member of the set. Those skilled in the art will appreciate that many other equivalent ways of representing the set of L possible channelization parameters may be used as well. In any case, the set {bᵢ} which specifies the L possible channelization parameters is determined in real time from subscriber-specific traffic workload information 45 and possibly other subscriber-specific information, such as type of service (voice or data), type of traffic (examples of types of traffic for data service include TCP (for web browsing), FTP (for file transfer), streaming applications for video and audio, email) and priority level (e.g., based on subscriber subscription fee). The above-mentioned subscriber-specific information imply different quality of service (e.g., delay) requirements and therefore different scheduling requirements.

Based on the set of channelization parameters {bᵢ} and the set of transmission mode parameters {mᵢ}, MAC scheduler 46 then selects a particular channelization parameter and a particular transmission mode parameter. In a first case, MAC scheduler 46 independently selects a particular channelization mode parameter, and then selects a particular transmission mode parameter in dependence upon the selected channelization mode parameter. If, however, the feedback contains only one transmission mode parameter, then the selection of this parameter is trivial, and does not depend on the selected channelization mode parameter. In a second case, MAC scheduler 46 jointly selects both a particular channelization mode parameter and a particular transmission mode parameter.

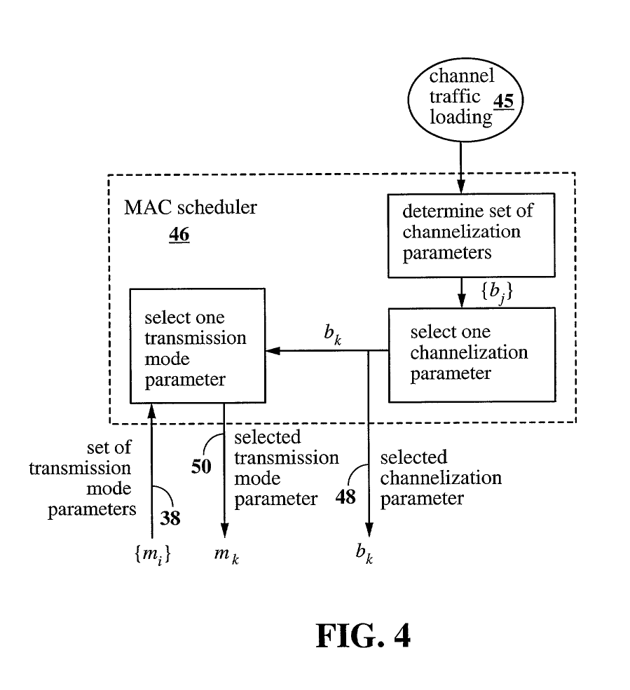

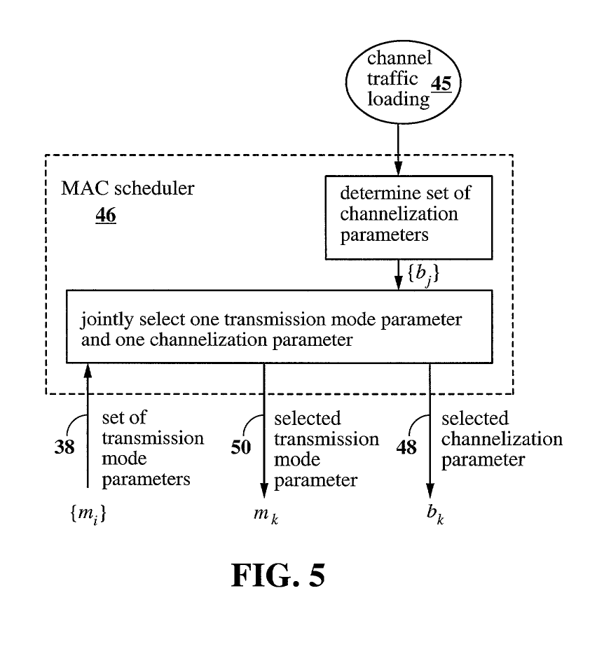

The details of these channelization and transmission mode selection processes will now be described with reference to FIGS. 4 and 5. In the first case, illustrated in FIG. 4, a particular channelization parameter bₖ is first selected from the set of several possible channelization parameters, {bᵢ}. The selection of a particular channelization parameter from this set is preferably based on the system traffic load, defined as the total traffic load shared among all simultaneous active subscribers. For example, in a system with only one active subscriber, the channelization parameter selected would be the maximum value of the set {bᵢ}. Alternatively, in a system with multiple active subscribers, the channelization parameter selected for each subscriber would be most likely smaller than the maximum value of the set. It would be chosen based on each subscriber's relative need, and with a view to balancing the system access among subscribers, while meeting every subscriber's quality of service requirements.

If the feedback contains a set of multiple transmission mode parameters, the particular transmission mode parameter is selected from this set in dependence upon which channelization parameter has been selected. Thus, after a particular channelization parameter bₖ is selected from the set {bᵢ}, it is used to select the corresponding transmission mode parameter mₖ from the set {mᵢ}. In other words, if the k^{th} system channelization mode parameter is selected from {bᵢ}, then the transmission mode parameter is selected from {mᵢ} which corresponds to the k^{th} system channelization mode parameter. If the feedback contains a set of just one transmission mode parameter, the particular transmission mode parameter is selected from this set in a trivial manner. The selection in this case does not depend upon which channelization parameter has been selected. Thus, both parameters are selected independently.

In the second case, illustrated in FIG. 5, the channelization and transmission mode parameters are jointly selected from the set of channelization parameters {bᵢ} and the set of transmission mode parameters {mᵢ}. In this case, a particular channelization parameter bₖ and particular transmission mode parameter mₖ corresponding to bₖ are selected from the sets {mᵢ} and {bᵢ} such that the subscriber throughput is optimized. For example, suppose integer parameters are designed so that a smaller value from the set {bᵢ} corresponds to a smaller number of blocks (i.e. fewer tones), and so that a smaller value from the set {mᵢ} corresponds to a lower modulation rate and coding rate. Then subscriber throughput is optimized when the pair of parameters is selected whose product is largest. In other words, the pair of parameters (mₖ, bₖ) is selected which maximizes mᵢbᵢ, where i=1, . . . , B. Note that since bᵢ=0 for all but the L possible channelization modes, the only non-zero products mᵢbᵢ will be those corresponding to the L possible channelization modes.

Those skilled in the art will recognize that other techniques and criteria for jointly selecting both parameters can also be used. For example, instead of independently selecting for each subscriber a pair of parameters that maximizes the product mᵢbᵢ for each subscriber separately, it is possible to jointly select all the parameter pairs (m_{s,k(s)}, b_{s,k(s)}) for all the subscribers s in such a way that the selected pairs maximize the sum over all subscribers s of the products m_{s,i}b_{s,i}. (Here m_{s,i} denotes the i^{th} transmission mode parameter for subscriber s, and b_{s,i} denotes the i^{th} channelization mode parameter for subscriber s, while k(s) denotes the index for the selected channelization mode parameter and transmission mode parameter for subscriber s.) In this scenario, not every user will get maximum throughput, but the aggregate throughput for the system is maximized.

Referring back again to FIG. 3, after MAC scheduler 46 selects particular channelization and transmission mode parameters by a technique such as those described above, the MAC scheduler allocates receiver data 47 to particular time/frequency portions of the spectrum, and provides the allocated data, together with the selected transmission and channelization mode parameters, to an encoding and modulation block 54, where it is coded and modulated in accordance with the selected transmission mode parameter and the selected channelization parameter, and transmitted over the wireless channel to the receiver 22.

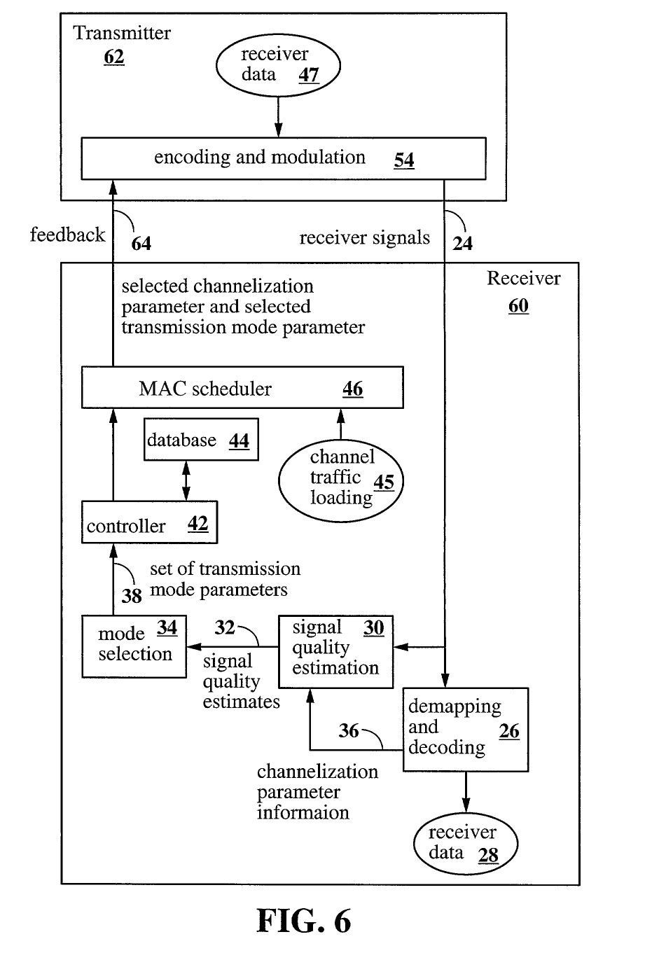

FIG. 6 illustrates an alternate embodiment of the invention. This embodiment is applicable, for example, to the uplink transmission from a subscriber to a base station. Thus, the transmitter in this case is the subscriber, and the receiver is the base station. Unless otherwise specified below, all of the elements in FIG. 6 and their functionality are identical to the analogous elements of FIG. 3 described above. The main difference is that the MAC scheduler, controller, and database are now in the receiver 60 rather than in the transmitter 62. In other words, the system is essentially identical, with the exception that the components of the system have been divided between the transmitter 62 and receiver 60 differently. Thus, rather than feeding back the set of possible transmission mode parameters 38, the selected transmission mode parameter 48 as well as the selected channelization parameter 50 are sent as feedback from the receiver 60 to the transmitter 62. The transmitter 62 receives the parameters and simply uses them to appropriately encode and modulate the receiver signals. The receiver 60 performs signal quality estimation and transmission mode selection just as in the system of FIG. 3. The set of transmission mode parameters, however, is not sent as feedback, but provided directly to the controller, which is also in the receiver 60. The MAC scheduler 46 in the receiver then selects the transmission mode parameter and channelization parameter, just as described in FIG. 3, but sends this information to the transmitter as feedback 64 so that it may be used for encoding and modulation of the transmitted signals.

1. In a wireless communication system comprising a transmitter and a receiver, and a corresponding wireless channel through which the receiver and the transmitter communicate, a method implemented at the transmitter comprising:
a) receiving feedback from the receiver, wherein the feedback comprises a set of transmission mode parameters derived from signal quality estimates and channelization parameter information;
b) selecting a channelization parameter from a set of possible channelization parameters, and a transmission mode parameter from the set of transmission mode parameters received from the receiver;
c) transmitting receiver data over the wireless channel to the receiver in accordance with the selected transmission mode parameter and the selected channelization parameter.

2. The method of claim 1 wherein the selected channelization parameter is adaptively selected to depend upon a real time system traffic load.

3. The method of claim 1 wherein the selected channelization parameter determines time/frequency channel allocation constraints.

4. The method of claim 1 wherein step (c) comprises transmitting the subscriber data over a set of frequency tones determined by the selected channelization parameter.

5. The method of claim 1 further comprising selecting the set of possible channelization parameters from a set of system channelization parameters using subscriber-specific information.

6. The method of claim 1 wherein step (b) comprises selecting the channelization parameter independent of selecting the transmission mode parameter.

7. The method of claim 1 wherein step (b) comprises selecting the transmission mode parameter in dependence upon the selected channelization parameter.

8. The method of claim 1 wherein step (b) comprises jointly selecting the channelization parameter and the transmission mode parameter together.

9. The method of claim 1 wherein the transmission mode parameter represents a transmission mode selected from the group consisting of coding mode, coding rate, modulation mode, modulation rate, and antenna diversity mode.

10. In a wireless communication system comprising a transmitter, a receiver, and a corresponding wireless channel through which the receiver and the transmitter communicate, a method implemented at the receiver comprising:
a) receiving signals transmitted from the transmitter over the wireless channel;
b) determining from the received signals signal quality estimates for the wireless channel;
c) determining from the signal quality estimates and channelization parameter information a set of transmission mode parameters;
d) feeding back the set of transmission mode parameters to the transmitter.

11. The method of claim 10 determining the signal quality estimates comprises using channelization parameter information to produce signal quality estimates corresponding to received signals transmitted using different channelization modes.

12. The method of claim 10 wherein each element of the set of transmission mode parameters corresponds to a unique system channelization parameter.

13. The method of claim 10 wherein step (b) comprises calculating statistics of signal quality levels of corresponding received signals transmitted with various channelization parameters.

14. The method of claim 10 wherein step (b) comprises separating signal quality levels by channelization parameter into separate groups.

15. The method of claim 14 wherein step (b) comprises normalizing the signal quality levels in each of the separate groups based on channelization parameter, and calculating statistics of the normalized signal quality levels.

16. In a wireless communication system comprising a transmitter, a receiver, and a corresponding wireless channel through which the receiver and the transmitter communicate, a method comprising:
a) feeding back from the receiver to the transmitter a set of transmission mode parameters;
b) selecting at the transmitter a channelization parameter from a set of possible channelization parameters, and a transmission mode parameter from the set of transmission mode parameters fed back from the receiver;
c) transmitting to the receiver from the transmitter receiver signals transmitted in accordance with the selected transmission mode parameter and the selected channelization parameter;
d) determining at the receiver from the transmitted receiver signals a set of signal quality estimates for the wireless channel;
e) determining at the receiver from the set of signal quality estimates a set of new transmission mode parameters for feedback to the transmitter.

17. The method of claim 16 wherein the set of new transmission mode parameters is determined additionally from channelization parameter information.

18. The method of claim 16 wherein the set of new transmission mode parameters consists of one transmission mode parameter.

19. The method of claim 16 wherein the selected channelization parameter is adaptively selected to depend upon a real time system traffic load.

20. The method of claim 16 further comprising selecting the set of possible channelization parameters from a set of system channelization parameters using subscriber-specific information.

21. The method of claim 16 wherein each transmission mode parameter corresponds to a unique system channelization mode parameter.

22. The method of claim 16 wherein step (b) comprises selecting the channelization parameter independent of the set of transmission mode parameters.

23. The method of claim 16 wherein step (b) comprises selecting the transmission mode parameter in dependence upon the selected channelization parameter.

24. The method of claim 16 wherein step (b) comprises jointly selecting the channelization parameter and the transmission mode parameter together .

25. The method of claim 16 wherein the transmission mode parameter represents a transmission mode selected from the group consisting of coding mode, coding rate, modulation mode, modulation rate, and antenna diversity mode.

26. The method of claim 16 wherein step (d) comprises calculating statistics of signal quality levels of corresponding received signals transmitted with various channelization parameters.

27. The method of claim 16 wherein step (d) comprises separating signal quality levels by channelization parameter into separate groups.

28. The method of claim 27 wherein step (d) comprises normalizing the signal quality levels in each of the separate groups based on channelization parameter, and calculating statistics of the normalized signal quality levels.

29. In a wireless communication system comprising a transmitter, a receiver, and a corresponding wireless channel through which the receiver and the transmitter communicate, a method comprising:
a) determining at the receiver a set of signal quality estimates for the wireless channel;
b) determining at the receiver a set of transmission mode parameters from the signal quality estimates;
c) selecting at the receiver a selected channelization parameter from a set of possible channelization parameters;
d) selecting at the receiver a selected transmission mode parameter from the set of transmission mode parameters;
e) feeding back from the receiver to the transmitter the selected transmission mode parameter and the selected channelization parameter;
f) transmitting receiver signals from the transmitter to the receiver in accordance with the selected transmission mode parameter and the selected channelization parameter.

30. The method of claim 29 wherein the set of transmission mode parameters is determined additionally from channelization parameter information.

31. The method of claim 29 wherein selecting the channelization parameter is independent of the set of transmission mode parameters.

32. The method of claim 29 wherein step (d) comprises selecting the transmission mode parameter in dependence upon the selected channelization parameter.

33. The method of claim 29 wherein steps (c) and (d) are performed together, so that the channelization parameter and the transmission mode parameter are selected jointly.
